(19) United States
(12) Patent Application Publication
(10) Pub. No.: US 2008/0260918 A1
(43) Pub. Date: Oct. 23, 2008

(54) Manufacturing method of three-dimensional food by rapid prototyping

(76) Inventors: Wei-Hsiang Lai, Tainan City (TW); Chun-I Cheng, Jiading Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/785,930

(22) Filed: Apr. 23, 2007

(51) Int. Cl. A23P 1/00; A23P 1/08

(52) U.S. Cl. 426/231

(57) ABSTRACT

This invention discloses a manufacturing method for producing three-dimensional food in a very short time without using a mold. The key technology is to establish a figure or word character in a computer-aided design (CAD) software such as CATIA, Pro/E, I-Deals, Solidwork, and AutoCAD or use a built-in figure and word of the Window system. The figure or word character is built into a three-dimensional model and transformed into a file with an *.stl format. Finally, a rapid prototyping (RP) machine is used to build the 3D food, and then the finished goods of the 3D food are produced. The invention promotes the food manufacturing method from 2D to 3D and accomplishes a substantial progress on the application of rapid prototyping.

### FIELD OF THE INVENTION

The present invention relates to rapid prototyping, and more particularly to a moldless manufacturing technology that adopts a 3D mold design to combine an edible powder and an edible binding material and uses 3D printing for manufacturing three-dimensional food.

### BACKGROUND OF THE INVENTION

Most of the traditional three-dimensional food manufacturing technologies are accomplished by a hand-made sculpture of a carver or a print transfer from a mold. For instance, candies or pastries are usually formed by a wood-carved shallow disc-shape print transfer mold or a quick manual shaping. Due to the limitations on the characteristics of food materials and the demolding process, too many choices are available for the appearance, size and other aspects of the finished goods, and a vast majority of the finished goods are one-sided 3D or embossed only. If it is necessary to produce a fancy three-dimensional food, then the manual shaping or carving is needed, but the manual shaping or carving method incurs a long carving time and a high labor cost, and the speed for making innovative changes and conducting a mass production cannot meet the requirements for actual practices. Furthermore, the 3D shape and form created by manual shaping and carving are usually restricted by the food material, and thus it cannot fit the fine and complicated stylish changes.

In addition, the food produced by powder requires a coloring process to produce a colorful and appealing food, regardless of the manufacturing method adopted. Since food is painted stroke by stroke manually or drawn by a professional artist, the whole process consumes too much time and cannot meet the cost-effective requirement for mass production. Furthermore, the manufacturing quality and artistic look of the food cannot be controlled or standardized easily.

In the past decade, computer aided design/manufacture (CAD/CAM) advanced, and manufacturers developed a rapid prototyping (NP) technology for a rapid manufacture of products from original design concepts. The rapid prototyping (RP) technology is not limited by the shape or form of the manufactured object. The more complicated the shape of an object, the better performance is the RP technology. In addition, the RP technology can save tremendous manpower and manufacturing time. With the requirement of maximizing the manufacturing time, different geometric shapes and curves of an object or a figure generated by CAD can be accomplished.

There are many different rapid prototyping (RP) methods including 3D printing, stereo-lithography (SLA), selective laser sintering (SLS), solider process (SP), fused deposition modeling (FDM), laminated object manufacturing (LOM), office RP, and rapid concept modeler (RCM), and RCM is the latest and most cost-effective method among the aforementioned ones and capable of producing a model rapidly from a design diagram drawn according to a designer's conceptual design to improve existing drawbacks and cast a new mold for the production directly. Such arrangement not only expedites the creation and shortens the development time of finished goods, but also saves a substantial amount of costs for the development.

Materials can be divided by RP into different kinds: a solid (such as the material for LOM), a liquid (such as the material for SLA), and a powder (such as the material for SLS), but the manufacture by binding powders has the fastest speed among various different rapid prototyping methods that are applied to the materials, and this method requires no additional support for creating the 3D shape and form. Therefore, the inventor of the present invention uses an appropriate food powder to go with drinking water or edible oil and adopts the aforementioned RP printing technology to produce three-dimensional food with different colors, shapes and sizes directly and quickly. With the RP printing technology, thousands of low-priced edible tiny powders can be used for producing the three-dimensional food of a desired shape in appropriate conditions and compositions.

As to the original intention of the RP, the purpose of rapid prototyping is to lower the cost of a relatively expensive material required for a preliminary conceptual design or a prototype of a product. As to the preliminary stage of the conceptual design, a more cost-effective, safer and quicker method for combining an appropriate food powder and a binder and applying this method in the manufacture of food by a RP machine can produce various different kinds of three-dimensional food.

### SUMMARY OF THE INVENTION

Therefore, it is a primary objective of the present invention to provide a manufacturing method for three-dimensional food by a rapid prototyping technology, such that the three-dimensional food in various complicated shapes can be produced rapidly and conveniently, so as to enhance the artistic look and value of the food and promote the food culture and related industry.

To achieve the aforementioned objective, the inventor of the present invention developed a manufacturing method for three-dimensional food by a rapid prototyping technology, and the manufacturing method comprises the steps of:

(1) confirming a customer requirement for a three-dimension figure and a word character;

(2) inputting the customer requirement into a computer;

(3) dimensionizing and coloring graphic and text data that are processed by a 3D processing software, and further computing or processing the data;

(4) combining the final figure and coverting the figure into a file with a slicing layer format (*.STL format);

(5) sending the slicing layer data to a rapid prototyping machine and preparing to start the manufacture of the three-dimensional food;

(6) driving a nozzle to spray a binder rapidly back and forth by a rapid prototyping machine according to the graphic data sent from the slicing layer software, and manufacturing the three-dimensional food;

(7) removing the finished goods of the three-dimensional food from the rapid prototyping machine and carrying out a post processing.

### BRIEF DESCRIPTION OF THE DRAWINGS

The file of this patent contains at least one Drawing Figure executed in color. Copies of the patent with color Drawings will be provided by the Patent and Trademark Office upon request and payment of the necessary fee.

FIG. 1 is a schematic view of powder stacking and binding processes performed by a rapid prototyping machine in accordance with the present invention;

FIG. 2 is a flow chart of a manufacturing method for three-dimensional food by rapid prototyping technology in accordance with the present invention; and

Attachment 1 shows a photograph of a three-dimensional food sample with different stylish designs manufactured by the method in accordance with the present invention.

### DETAILED DESCRIPTION OF THE PREFERRED EMBODIMENTS

The technology employed by the present invention is partially similar to the researches oil rapid prototyping conducted by M.I.T. at an earlier time and disclosed in U.S. Pat. Nos. 5,204,055, 5,340,656, 5,387,380 and 5,902,441. Although these patented inventions focus on the 3D shaping methods, skills and equipments, many further researches and developments on the use of powder materials for the manufacture are being conducted, and the scope of applicability of these technologies is completely irrelevant to the food industry, and such technologies are unable to produce three-dimensional food in a short time. The key points of the present invention reside on the manufacturing method and procedure for three-dimensional food instead of the structure of a rapid prototyping machine and the composition of the powder material for producing food. However, the specification of this invention still provide a brief description on the structure and principle of a general rapid prototyping machine and the composition of powder materials for producing food.

(I) Rapid Prototyping Machine, Equipment and Manufacturing Process:

The rapid prototyping machine mainly uses an inkjet printer head to spray or coat a binder into the powder layer by layer to achieve the effect of binding the powder. Theoretically, the main purpose of the binder is to produce a binding effect between powders, so that the powder has strong Van der Waals bonds, or even is chemically reacted to produce ionic bonds or covalent bonds to enhance the chemical bonds and construct a three-dimensional object.

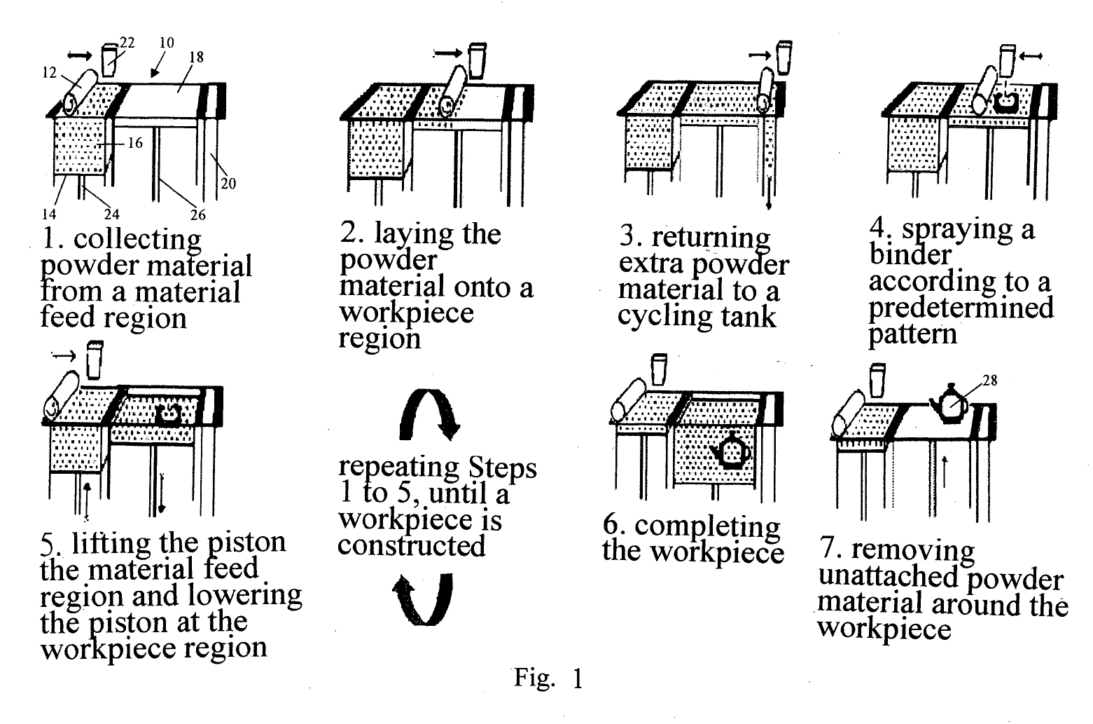

In the rapid prototyping process of the present invention, the inkjet printer head of the rapid prototyping machine 10 sprays a binder back and forth onto each layer of powder, so that the powders at the sprayed regions can have a binding effect with each other. Referring to FIG. 1 for a brief description of the powder stacking and binding process of a rapid prototyping machine, the process comprises the steps of:

1. using a powder laying roller 12 to collect sufficient powder material 16 from a material feed region 14;

2. laying the powder material 16 onto a workpiece region 18;

3. returning extra powder material 16 to a cycling tank 20 for collection and storage;

4. spraying a binder according to a predetermined pattern by an inkjet printer head 22;

5. lifting the piston 24 at the material feed region and lowering the piston 26 at the workpiece region;

6. repeating Steps 1 to 5, until a workpiece 8 is constructed;

7. lifting the piston 26 at the workpiece region, and removing unattached powder material 16 around the workpiece 28.

(II) Powder and Binder:

The present invention adopts a rapid shaping powder as the food powder material, wherein the food powder material can be edible gypsum powder, flour, glutinous rice flour, corn starch, chocolate powder and other edible powders, and the particles of food powder adopted by the present invention may come with different sizes and play differents roles according to their compositions. Various different powders play the role of a filler (which is a primary constituent of the food powder), a stabilizer (which is a secondary constituent of the food powder), and a fortifier (which is a binding promoter), and a special adhesive (which assists the binding of a binder), etc. As to the binder, its main solvent can be drinking water or edible oil, and the secondary solvent can be edible dye or edible flow promoter for increasing the mobility of the binder and adjusting the tiny holes of the inkjet printer head to prevent them from being clogged, in order to improve the life expectancy of the inkjet printer head. There are edible coagulation promoter and nano promoting filler, and the main function of the coagulation promoter is to expedite a ripening process, so that the finished goods can be removed from the rapid prototyping machine immediately instead of occupying the machine for some time, and the nano promoting filler uses an accessory adhesive to fill up the tiny hole of the particulates in order to improve the binding between the food powder and the binder, and the strength of a shaped three-dimensional food can be controlled. Such arrangement not only produces food with a stylish appearance, but also controls the size and precision of the object, so as to meet the requirements for the actual packaging.

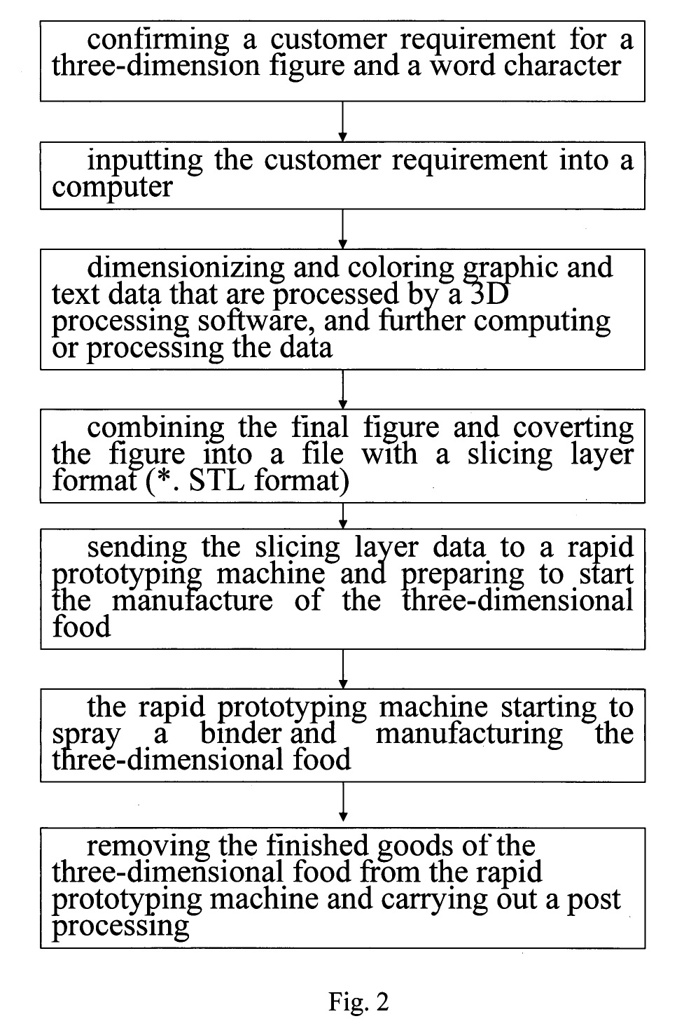

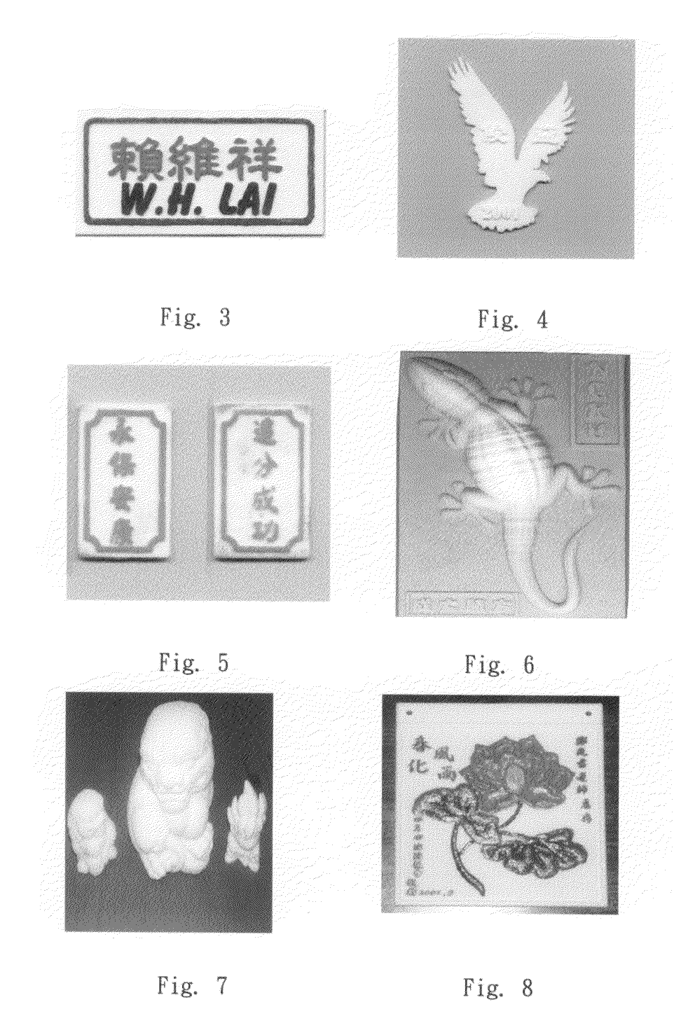

(III) Manufacturing Method and Procedure of Three-dimensional Food (as Shown in FIG. 2):

1. Confirming a customer requirement on a three-dimensional figure and a word character: The invention aims at market satisfactions or tailor-made requirements, and thus the invention can adopt a 3D file of a design created by customers or by the conceptual design of customers for drawing or reverse scanning an OEM 3D file and obtains a mutual understanding through the communications of language, samples, or figures, and then converts the result of the design into a file with a format executable by the rapid prototyping machine, and selects a powder material of a desired flavor for the rapid 3D food manufacturing.

2. Inputting the customer requirement into a computer: Search a built-in figure or word in a computer system according to a customer's written information, or read the figure or word created by a customer, or use a scanner or a camera, if necessary, to scan the text and graphic data into the computer.

3. Dimensionizing and coloring the text and graphic data by a 3D post-processing software for further computation and processing: Since the obtained text and graphic data cannot be used directly by a computer software, it is necessary to process the data by another 3D post-processing software and create point data around the perimeter and then combine the points into a surface and the surfaces into a physical object to provide a 3D figure. The 3D model can be processed or colored if needed, and then the 3D software can be used for executing the Boolean operations including union, intersection, AND, and OR, in order to achieve the 3D effects by combining graphics and texts according to the font, size, and embossment of the texts required by customers. The 3D software also can be used for duplicating, arranging, turning or mirroring a portion of the text and graphic data to make the original texts and graphics livelier and improve customer satisfaction.

4. Linking and converting the final figure into a file with STL format: Convert the created 3D object into a file with a format of (*.stl), ascii VRML file (*.wrl), SolidView SFX file (*.sfx), Binary PLY file (*.ply) and comprised of a surface with numerous meshes on a close meshed plane, so that a top-down programmable control can be used to compute the digital slices through a computer and obtain the data of the cross section and shape of slicing layers at every different height of the object.

5. Sending the STL data to the rapid prototyping machine and preparing to start the manufacture: rapid prototyping machine: Only a file in the format *.stl can be read, and the shape of the corresponding product can be displayed on the screen. Rapid prototyping machines of this sort have been developed by the inventor of the present invention and his team and disclosed in R.O.C. Pat. Application No. 93118961 entitled “3D rapid shaping machine” as well as the Z402, Z310, Z406 and Z510 3D printers of Z-Corp, the Thermojet SLA or SLS of 3D System Company, and the FDM printing machine of Stratasys Company. If colors are required, the Z402C, Z406 3D and Z510 printers are used for the manufacture of the product, or the manufactured product is colored by a skillful person.

6. The rapid prototyping machine starts spraying a binder and manufacturing the three-dimensional food, and the details have been described in previous sections and illustrated in FIG. 1.

7. Removing the finished goods of three-dimensional food from the rapid prototyping machine and carrying out a post processing: At present, a powder stacking method is generally used for manufacturing three-dimensional food. Due to the factors of ripening time and structural strength of different food powders, a rigid slab can be placed in a workpiece region before the manufacture takes place, and the finished goods can be removed directly after the manufacture, but it is necessary to take out the finished goods and remove the excessive powder with care (see attachment 1 for a tested three-dimensional food sample in accordance with the present invention) or an automated operating procedure is designed for shortening the time from removing the machine to ripening; or a sealed packaging design is adopted for the quick shaping process, and both food powder material and binder are used for producing a carton and the three-dimensional food. The three-dimensional food and the loosened powders at its periphery that are not sprayed with a binder are sealed into the carton made of the same material as the food powder. The invention not only prevents the three-dimensional food from being ruined by external factors, but also creates a surprise for users when they open the carton and gives more fun to the food itself. After the three-dimensional food is removed from the carton, an appropriate post processing such as baking the food, or making use of the adsorbability of pores in the food powder to sprinkle an additive over the surface of the food without destroying the three-dimensional structure of the food, so as to add different flavors and colors to the food and improve the artistic look of the food.

In view of the description above, the present invention has the following advantages and effects:

1. Unlike the monotonous appearance of the traditional food, the present invention adds diversified, innovative, stylish designs for different kinds of food to meet the tailor-made requirements of a customer design. The invention not simply enhances the appeal of food, but also promotes industrial upgrade and market competitiveness of the food industry.

2. The invention adopts a rapid prototyping technology to produce the three-dimensional food, and also uses a quick computer design technology to shorten the time for the design and actual creations of the molds. Further, it is not necessary to design a food mold of a high strength, and thus a general rapid prototyping machine can be used directly for producing or duplicating the mold for the food material, and several sets of molds in different shapes can be produced within a short time to meet the requirements for a mass production of molds. Therefore, the invention can save tremendous development time and cost required for making a hand-made wood-carving or metal mold to meet the requirement of mass production.

3. The invention further integrates other innovative technologies (including rapid design and manufacture 3D word and pattern manufacturing process technology, integrated forward and reverse engineering technologies, 3D animation multimedia capturing design technology and casting technology) to meet the requirements for the recreational education or the casting industry.

What is claimed is:

1. A manufacturing method for three-dimensional food by rapid prototyping technology, comprising the steps of:
(1) confirming a customer requirement on a three-dimensional figure and a three-dimensional word character;
(2) inputting the customer requirement into a computer;
(3) dimensionizing and coloring graphic and text data processed by a 3D post-processing software, and computing or processing the data;
(4) combining a final figure and coverting the figure into a file with a STL format;
(5) sending a STL data to a rapid prototyping machine and preparing to start the manufacture;
(6) driving a nozzle to spray a binder rapidly back and forth by a rapid prototyping machine according to the graphic data sent from the slicing layer software, and manufacturing the three-dimensional food, and
(7) removing finished goods of the three-dimensional food from the rapid prototyping machine and carrying out a post processing.

2. The manufacturing method for three-dimensional food by rapid prototyping technology as claimed in claim 1, wherein the rapid prototyping machine is filled with an edible food powder that serves as a raw material, and the nozzle is filled with an edible binder. The food powder is composed of a filler, a stabilizer, a fortifier, a special adhesive and other food powders with different properties; and the binder includes a main solvent, an edible dye, a flow promoter, a coagulation promoter and a nano promoting filler. The food powder is edible gypsum powder, flour, glutinous rice flour, corn starch, chocolate powder or other edible powder. The main solvent of the binder is drinking water or editable oil, and the main solvent adds one or more dyes.

3. The manufacturing method for three-dimensional food by rapid prototyping technology as claimed in claim 1, wherein the 3D post-processing software includes CATIA, Pro-E, I-Deals, Solidwork, Solid edge, AutoCAD, TrueSpace, 3D MAX, FreeForm and other software.

4. The manufacturing method for three-dimensional food by rapid prototyping technology as claimed in claim 1, wherein the rapid prototyping machine includes a 3D Printer series of Z-Corp, a Thermojet printer of 3D system Company, SLA or SLS, and FDM of Stratasys Company, and any other machine for manufacturing an object rapidly.

5. The manufacturing method for three-dimensional food by rapid prototyping technology as claimed in claim 1, wherein the post processing sprays an edible additive onto the surface of an object by using a pore adsorbability of the food powder without damaging the shape of the object, so as to add different flavors or colors and enhance the artistic look of the three-dimensional food.
